(19) United States
(12) Patent Application Publication
(10) Pub. No.: US 2002/0023258 A1
(43) Pub. Date: Feb. 21, 2002

(54) System and method for managing telecommunications devices

(76) Inventors: Amgad Mazen Elwahab, Reno, NV (US); Michael Allan Pelster, Reno, NV (US); Todd Bedros Smith, Reno, NV (US)

Correspondence Address: Glenn M. Kubota, Esq., Morrison & Foerster LLP, 35th Floor, 555 W. 5th Street, Los Angeles, CA, 90013, US

(21) Appl. No.: 09/888,763

(22) Filed: Jun. 25, 2001

Related U.S. Application Data
(60) Provisional application No. 60/214,082, filed on Jun. 27, 2000.

(51) Int. Cl. G06F 9/44

(52) U.S. Cl. 717/122

(57) ABSTRACT

A method for remote management of network elements is disclosed. The method comprises communicating existing software version information from one or more network elements, checking the existing software version information against current software version information, and provisioning those network elements containing outdated software versions by communicating a current software version to those network elements. In addition, the communication of the existing software version information from the one or more network elements and the communication of the current software versions to the network elements may be accomplished using a simple network management protocol (SNMP).

### CROSS-REFERENCE TO RELATED APPLICATIONS

Embodiments of the present invention claim priority from U.S. provisional patent application Serial No. 60/214,082 entitled “System and Method for Managing Customer Premises Gateways,” filed Jun. 27, 2000, and are related to a U.S. utility application entitled “Device, System and Method for Providing Web Browser Access and Control of Devices in Customer Premise Gateways,” attorney docket no. 080632.0109, filed Jan. 12, 2001, the contents of which are incorporated herein by reference for all purposes.

### BACKGROUND OF THE INVENTION

1. Field of the Invention

The present invention relates, generally, to element management systems and, in preferred embodiments, to systems and methods for enabling network and service providers to efficiently manage telecommunications devices, including customer premise gateways (CPGs).

2. Description of Related Art

In today's telecommunication world, telecommunication companies are employing a variety of telecommunication devices which include, but are not limited to, asynchronous transfer mode (ATM) switches, routers, digital subscriber line access modems (DSLAMs), and public switched telephone network (PSTN) switches in their central offices. Initially, no standard protocol existed for management of these devices. In time, however, a standardized protocol called TL-1 was developed and used by the telecommunication industry for managing switches and legacy devices, which include ATM switches, trunks, class 5 switches, and the like. Unfortunately, the TL-1protocol does not extend itself well for Internet Protocol (IP) management.

Within the last 12 years, however, an IP-based protocol known as simple network management protocol (SNMP) was developed. SNMP operates at the Open Systems Interconnection (OSI) Application layer, and may be used to manage personal computers (PCs), printers, routers, switches of different types, and other devices that can be connected to a network. For example, SNMP may be used for communications between devices coupled to an Ethernet. SNMP has gained widespread acceptance within the telecommunications and computing industry, and thus a whole new generation of communication devices have been developed that utilize SNMP as their management protocol. Telecommunication service providers have followed, and are now standardizing their network management protocols to SNMP. However, many telecommunications devices still do not have standardized device management protocols, which has heretofore precluded the remote management of such devices.

For example, a customer premise may contain a number of controllable devices, appliances and systems such as heating, ventilation, and air conditioning (HVAC), lighting, and security systems, hereinafter referred to as “smart devices.” The U.S. utility application entitled “Device, System and Method for Providing Web Browser Access and Control of Devices in Customer Premise Gateways,” attorney docket no. 080632.0109, filed Jan. 12, 2001, discloses a CPG for providing centralized Markup-Language-type enabled (including XML enabled) web browser access and control of these smart devices. However, the smart devices may not employ standardized management protocols such as SNMP, and thus a tool is needed to manage the CPG and the smart devices, and provide a generic methodology to manage services for efficient installation of needed network and service provider software upgrades in the CPG, execute service provider features, and enable collection and transmittal of data collected from the smart devices at the customer premise.

### SUMMARY OF THE DISCLOSURE

It is an advantage of embodiments of the present invention to provide a method for remote management of telecommunications devices that do not have standardized device management protocols.

It is a further advantage of embodiments of the present invention to provide a method for managing a customer premises gateway and smart devices coupled to the customer premises gateway.

It is a further advantage of embodiments of the present invention to provide a generic methodology to manage services for efficient installation of needed network and service provider upgrades in the customer premises gateway, execute service provider features, and enable collection and transmittal of data collected from the smart devices at the customer premised.

The above-described and other advantages are accomplished according to a method for remote management of network elements. The method comprises communicating existing software version information from one or more network elements, checking the existing software version information against current software version information, and provisioning those network elements containing outdated software versions by communicating a current software version to those network elements. In addition, the communication of the existing software version information from the one or more network elements and the communication of the current software versions to the network elements may be accomplished using a simple network management protocol (SNMP).

### BRIEF DESCRIPTION OF THE DRAWINGS

FIG. 1 is a block diagram illustrating a CPG and an element management system (EMS) tool in a system environment according to an embodiment of the present invention.

FIG. 2 illustrates SNMP communication between an EMS tool and a CPG according to an embodiment of the present invention.

FIG. 3 is a block diagram illustrating in greater detail SNMP communications between an EMS tool and a CPG according to an embodiment of the present invention.

FIG. 4 is a block diagram illustrating frameset redirection in an advertisement manager embodiment of the present invention.

### DETAILED DESCRIPTION OF PREFERRED EMBODIMENTS

In the following description of preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the preferred embodiments of the present invention.

### Element Management System Tool

Embodiments of the present invention disclose an element management system (EMS) tool for managing “network elements,” which includes switches, routers, DSLAMS, trunks, Integrated Access Devices (IADs), CPGS, and smart devices within a customer premise. The present invention also provides a generic methodology for managing services, including the efficient installation of needed network and service provider software and upgrades (software provisioning), the execution service provider features, and enabling collection and transmittal of data collected from the smart devices at the customer premise. Conventional EMS tools have comprised software dedicated to specific devices and capable of only rudimentary customer premises gateway configuration capabilities, such as controlling lights in a home. In contrast EMS tools according to embodiments of the present invention provide the novel capability of managing a greater variety of services through a CPG, which includes, but is not limited to, smart appliances, personal computing devices, video, and voice.

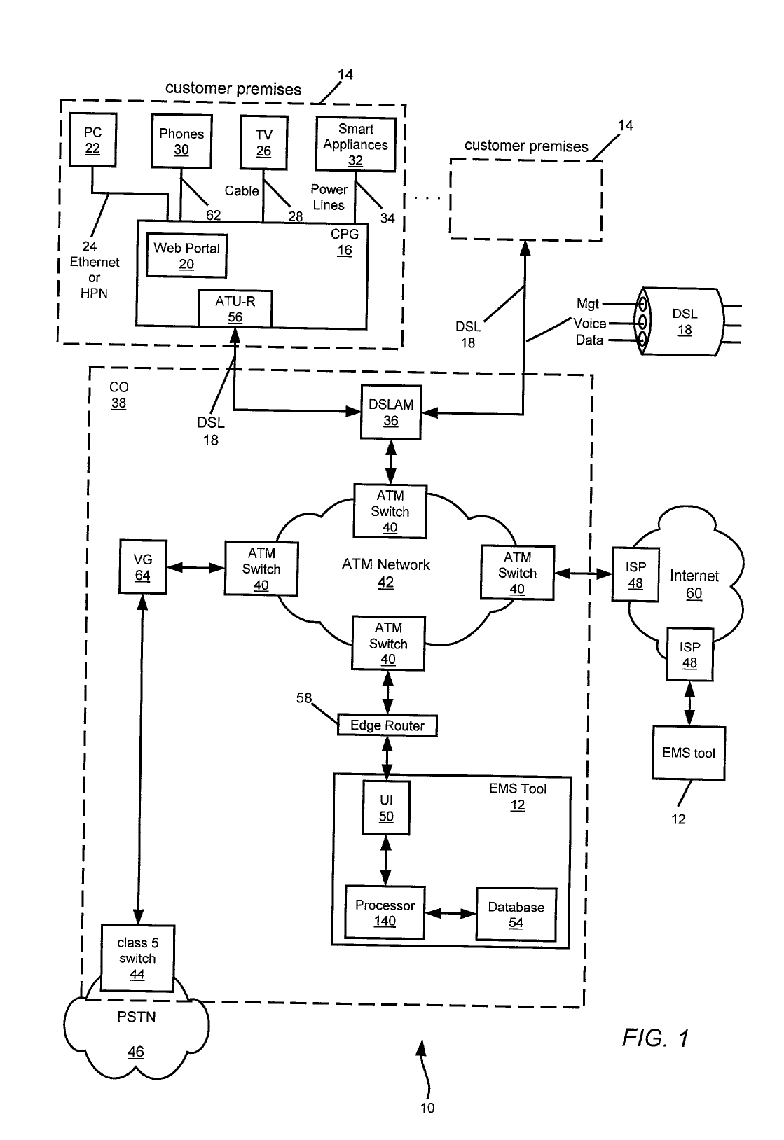

FIG. 1 illustrates EMS tools 12 located in an example system environment 10 according to an embodiment of the present invention. In system 10, a plurality of customer premises 14 are shown. Each customer premise 14 includes a CPG 16 capable of communicating with the outside world through a digital subscriber line (DSL) 18. DSL 18 is capable of carrying different types of data. Conceptually, DSL can be envisioned as a large piece of conduit, with separate smaller conduits inside carrying management information (mgt), voice, and data. Included within CPG 16 is an embedded Web server 20 and an ADSL Transmission Unit—Remote (ATU-R) 56.

Each CPG 16 may be connected to one or more personal computers (PCs) 22 through an Ethernet link or Home Phone Network Alliance (HomePNA) telephone line 24, video display devices 26 through a coaxial cable 28, telephones 30 through telephone lines 62, and smart appliances 32 through AC power lines 34. It is to be understood that this list is intended to be exemplary and not exclusive.

FIG. 1 also illustrates an example network provider central office (CO) 38, which includes asynchronous transfer mode (ATM) switches 40 connected in an ATM network 42. The ATM switches 40 are capable of interpreting ATM cells and routing these cells through the ATM network 42. One of the ATM switches 40 is connected to a voice gateway (VG) 64 and a class 5 switch 44 located in CO 38. VG 64 interfaces to the class 5 switches 44 using GR-303 or TR-08 requirements, and allows voice signals to be communicated between the public switched telephone network (PSTN) 46 and the CO 38 by converting analog voice signals into ATM cells, and vice versa. VG 64 takes voice data from class 5 switch 44, routes it over the ATM network 42 in this example, and eventually transmits the voice data in the form of voice over DSL (VoDSL) 18 to the customer premises.

In the system of FIG. 1, the ATU-R 56 in customer premises gateway 16 communicates with an ATM switch 40 via an ADSL Transmission Unit—Central Office (ATU-C) Digital Subscriber Line Access Multiplexer/Modem (DSLAM) 36. The DSLAM 36 and ATU-R-50 are capable of determining which frequency ranges have minimal interference, and establishing channels for communication. Although the example of FIG. 1 illustrates a DSLAM 36 capable of passing ATM cells between ATM network 42 and the customer premises gateways 16, DSLAM 36 may also be configured to pass other types of data such as Frame Relay data. DSLAM 36 may be located in the local network provider's central office (CO) 38, or at a remote location between the CO 38 and individual customer premises 14, where customers can benefit from the higher data rates achievable by locating the DSLAM 36 closer to the customer premises. In such systems, DSLAM 36 and the CO 38 may communicate via a fiber optic link.

In the example of FIG. 1, another ATM switch 40 is connected to an EMS tool 12 via an edge router 58. This EMS tool 12 is dedicated to controlling network elements within the CO 38. The EMS tool 12 includes a user interface (UI) 50, a processor 140, and an EMS database 54. It should be understood that the EMS tool 12 can also be implemented as a distributed system, distributed across multiple servers. Furthermore, multiple UIs 50 for a single EMS tool 12 may exist within a private local area network (LAN) or in public networks such as the Internet 60. Another ATM switch 40 is connected to an Internet Service Provider (ISP) 48, which provides Internet access for network elements connected to the CO 38. In addition, an EMS tool 12 is connected to the Internet 60 for remotely managing CPG 16s and smart devices within the customer premises 14.

EMS tool 12 may be used by network providers that require a way to control managed devices in the field. Network providers are the entities responsible for network connectivity. Competitive/Certified Local Exchange Carrier (CLECs) and Incumbent Local Exchange Carrier (ILECs) are examples of a network provider. The network provider may also provide services as well. In the case of a layered network, more than one network provider may be possible. For example, Internet Protocol (IP) network connectivity is usually provided by an ISP, but the local network (the network that connects to the CPGs 16 in the example of FIG. 1), which typically uses ATM over xDSL (a generic term for DSL equipment and services), is operated by the local telco. In this case the IP traffic from and to the ISP would be encapsulated inside the ATM network of the local telco. The local telco would be the primary network provider and the ISP would be a secondary network provider.

Referring to FIG. 1, network providers such as the local telco need a way to control a number of network elements in the telco's CO 38, such as ATM switches 40, VGs 64, or DSLAMs 36. If these network elements have standardized management protocols, the telco may be able to manage them directly, using EMS tool 12. Fox example, a local telco may have multiple specialized element management tools for controlling Operations Support Systems (OSSs) and Network Management Systems (NMSs) that gather and maintain billing and accounting information. An EMS tool 12 may interface to these specialized element management tools and extract customer records for copying into the EMS database 54.

The EMS tool 12 may be also used by service providers that require a way to control managed devices in the field. Service providers typically offer services that either run on or through a CPG 16, and includes, but is not limited to, voice, video, and data services. Service providers may be any entity that offers a service over the network to the CPG 16. For example, a service provider could be the provider of one brand of CPG 16 (e.g., ShareGate, Inc.). In this example, the EMS tool 12 would be capable of managing ShareGate, Inc.'s remote communication, monitoring, control and maintenance activities for their CPGs 16.

Continuing the present example for purposes of illustration only, ShareGate, Inc. would require a way to manage new and existing CPGs 16, manage the services being offered through their CPGs 16, provision their CPGs 16, and maintain the correct network interface software to allow access to the network provider's network. Referring to FIG. 1, suppose a customer has purchased a CPG 16 from ShareGate, Inc., and has connected the CPG 16 to a CO 38 through a DSL link 18. An ShareGate, Inc. operator, at ShareGate's facilities, can access an appropriate UI 50 of an EMS tool 12 and perform some provisioning steps. Control messages from the EMS tool 12 may be routed to an ISP 48, over the Internet 60, to the appropriate CO 38, and finally to the appropriate CPG 16. An embedded Web server 20 within the CPG 16 will interpret these control messages and configure the CPG 16 accordingly. With the EMS tool 12, a customer will not have to wait for service personnel to physically visit the customer premise (a truck roll) and configure a newly purchased CPG 16.

As illustrated in the example system of FIG. 1, communications between a telco CO 38 and a customer premise may be enabled through a DSL link 18. This type of network communication involves several layers of protocols. In the example of FIG. 1, the DSL link 18 uses IP over ATM over asymmetric digital subscriber line (ADSL).

In preferred embodiments of the present invention, the communication link between an EMS tool 12 and the CPG 16 is an SNMP connection. SNMP is an IP-based protocol used to communicate information through the DSL link 18 over IP. It should be understood that although embodiments of the present invention are described herein with respect to an SNMP-compliant CPG 16 for purposes of clarity, the EMS tool 12 is also capable of managing non-SNMP-complaint devices.

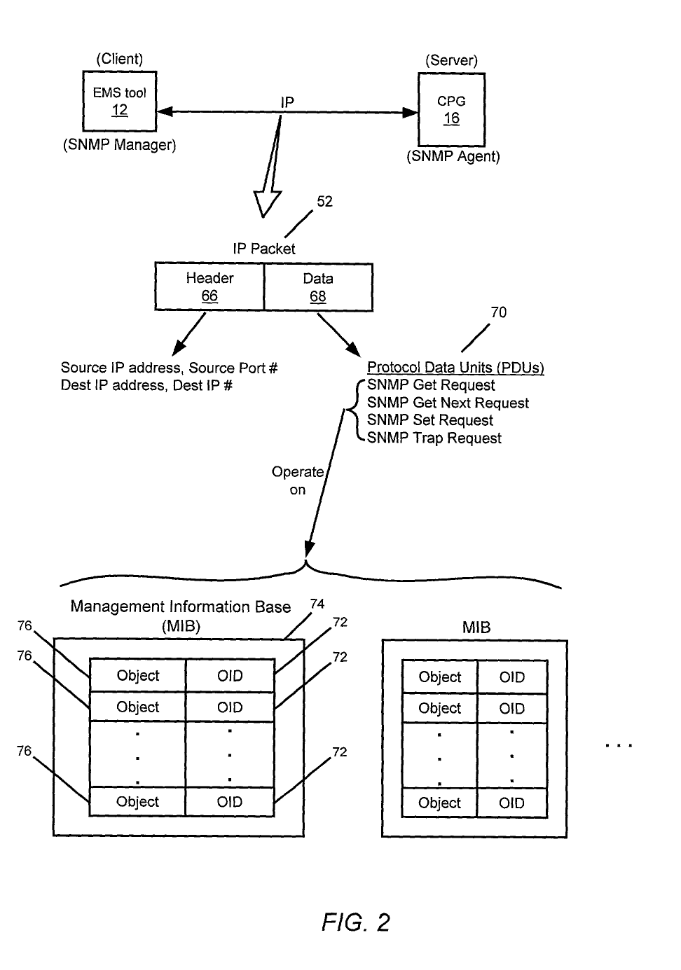

Referring to FIG. 2, a description of SNMP will now be provided. FIG. 2 illustrates a client and a server communicating over IP. An exemplary IP client/server model would be, for example, a Web browser (client) communicating with a Web server for a particular web site (server). However, in the example of FIG. 2, an EMS tool 12 acts as a client to a CPG 16, which acts as a server. The EMS tool 12 can also be described as an SNMP manager, while the CPG 16 can also be described as an SNMP agent. The client/server model uses pre-defined ports, so IP can be viewed as packet transport 52. In client/server communications, two sets of identifiers must be contained in each packet 52. As illustrated in FIG. 2, within each packet 52 is a header 66 containing these identifiers. These identifiers include a source IP address, a source port number, a destination IP address, and a destination port number.

In general, the whole IP infrastructure uses the destination IP address and destination port number identifiers to deliver an IP packet. For example, once an HTTP request or a request using a web browser is made, the domain name is translated into a destination IP address and a destination port number (port 80, a predefined and well known port number for all web servers). This destination information is then put into the header of the IP packet, and the HTTP request is communicated. Every server that receives this packet will attempt to pass it on to the proper web server. The web server will extract the source IP address and source port number, and send a response back to the requestor. Like HTTP, SNMP is another IP protocol that has a different set of predefined and well known ports, specifically ports 161 and 162. SNMP communicates these two ports to deliver device management packets. SNMP uses standard blocks of data for communication between end devices, or between end devices and an EMS tool 12.

Referring to FIG. 2, the data or payload 68 in SNMP includes an “SNMP set” or “SNMP get” request. The SNMP set command is an instruction to set a particular managed device with certain parameter values. A SNMP get request is a request for a particular web page. Other SNMP commands include “SNMP get next,” and “SNMP trap.” The SNMP commands that are communicated between the client 12 and server 16 are known as protocol data units (PDUs) 70.

The PDUs 70 operate on management information bases (MIBs 74. A MIB 74 is a database of characteristics and parameters (objects) managed in a network device. MIBs are the communication blocks within SNMP. Each MIB 74 contains multiple objects 76, each object uniquely defined by an object identifier (OID) 72. Each OID 72 contains a pointer to an instance variable used in communications between the client 12 and server 16. For each communication between a client and a server, the two must agree on which objects 76 and OIDs 72 are going to be used. For example, if the client 12 is an EMS tool and the server 16 is part of a router, then the EMS tool and the router must agree on the objects 76 and OIDs 72 they will use to communicate with each other.

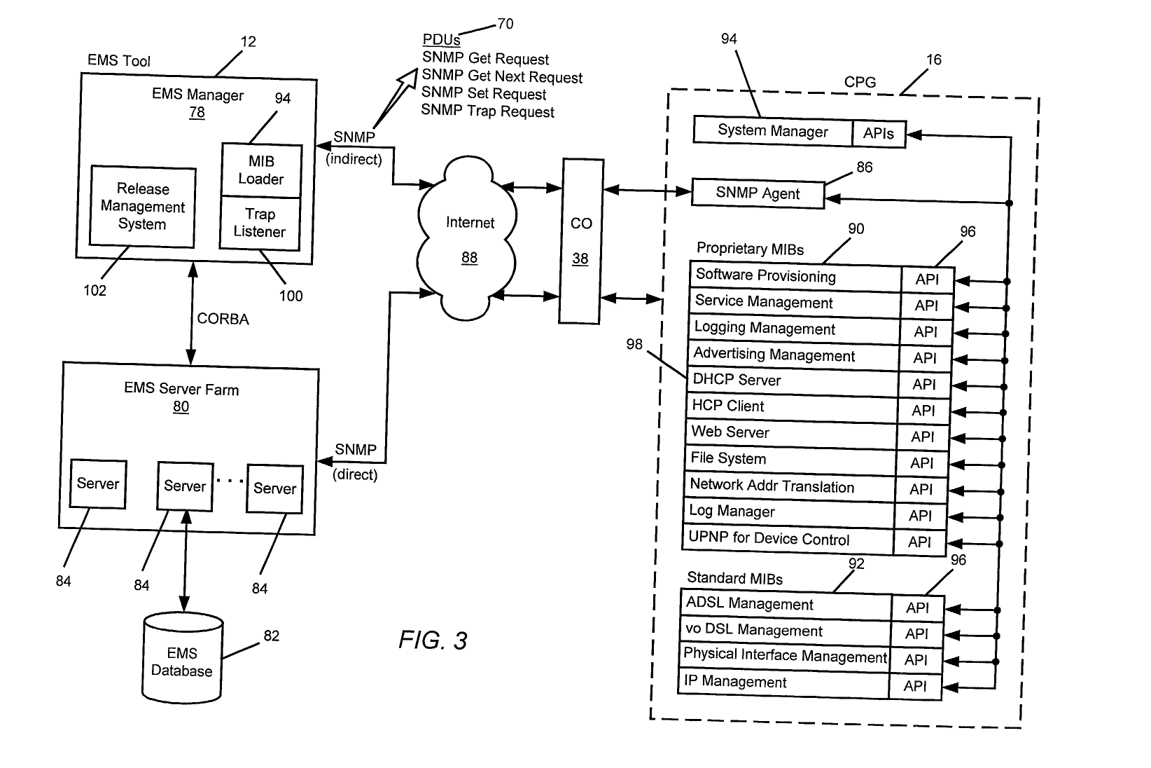

FIG. 3 illustrates an EMS tool 12 and a CPG 16 in a client/server model according to an embodiment of the present invention. The following discussion now presents an overview of gateway in reference to FIG. 3. Within EMS tool 12, there is an EMS manager 78 that communicates with an EMS server farm 80 through a Common Object Request Broker Architecture (CORBA). An EMS database 82 is also connected to the EMS server farm 80. The EMS server farm 80 is comprised of a set of servers 84. In some instances, an indirect mode of communication between the EMS tool 12 and an SNMP agent 86 within the CPG 16 will be used via the Internet (or other network) 88 and the CO 38, but in other instances, communications will also occur directly between the EMS server farm 80 and the MIBs in the CPG 16. Although most of the communications between the EMS tool 12 and the CPG 16 use SNMP, in some instances file transfer protocol (FTP) is used in coordination with SNMP to perform software provisioning.

As shown in FIG. 3, CPG 16 includes two types of MIBs, proprietary 90 and standard 92. The standard MIBs 92 include, but are not limited to, MIBs for ADSL management, voice over DSL management, ATM management, physical interface management and IP management, and the like. Each of these standard MIBs 92 is referenced by a request for comments (RFC) number, which is assigned to a particular MIB when the MIB is in the process of becoming standardized. Thus, only standard MIBs 92 are assigned an RFD number.

Proprietary MIBs 90 are MIBs written specifically for managing a particular CPG 16. Thus, one company may write proprietary MIBs 90 for its CPG product, while another company may write a different set of proprietary MIBs 90 for its CPG product. Proprietary MIBs 90 present an operational challenge for non-proprietary EMS tools 16, because an EMS tool 16 must have an understanding of the MIBs within the CPG being managed. In preferred embodiments of the present invention, the EMS tool 12 may employ a MIB loader 94 to perform a discovery function to discover the MIBs on the CPG 16 being managed. When the MIB loader 94 discovers proprietary MIBs 90, a set of predefined views will be generated for each data type that can be managed. However, if the proprietary MIBs 90 are configured to block the discovery process, then the EMS tool 12 will not be able to manage that particular CPG 16. In preferred embodiments of the present invention, the proprietary MIBs 90 include, but are not limited to, MIBs for software provisioning, service management, logging management, advertising management, and the like.

When a CPG 16 is first powered up, it performs a series of tasks (MIBs) in accordance with a bootstrap function. One of the first tasks performed is the system manager 94 (a proprietary MIB), which is executed at the earlier stages of the bootstrapping process. This sequencing is necessary because most of the other MIBs that are performed after the system manager will register with the system manager 94. Each of the MIBs listed in the gateway block in FIG. 3 registers an application programming interface (API) 96 with the system manager 94. These APIs 96 are used to control each MIB. The system manager 94 must also publish these APIs 96 so that when a MIB and the system manager 94 communicate, they are reading off of the same data structures.

For example, the Dynamic Host Configuration Protocol (DHCP) server MIB 98 will notify the system manager MIB 94 that it has a certain number of controllable parameters in a lease table, such as the gateway identifier (ID), the Digital Multiplex System (DMS) server ID, and other parameters. A set of APIs are also defined for controlling those parameters. Likewise each of the MIBs listed in the CPG 16 of FIG. 3 notifies the system manager 94 that a particular set of parameters with a particular set of control functions are associated with that MIB.

As stated above, when a CPG 16 is first powered up, the system manager 94 is one of the first MIBs to be executed. The system manager 94 is then responsible for starting and controlling all of the other MIBs. In other words, the system manager 94 is responsible for controlling all of the services that are operable on that particular CPG 16. Other proprietary MIBs controllable by the system manager 94 may include, but are not limited to, the DHCP server MIB 98, an HCP client MIB, an embedded web server MIB, a file system MIB, a network address translation MIB, a log manager MIB, a universal plug and play (UPNP) MIB for device control, and the like.

When a CPG 16 is first powered up and the system manager 94 starts all of the other MIBs, the system manager 94 must perform source code resolution. Source code resolution can be explained as follows. Assume, for example, that MIB A is to be executed by a system manager. Further assume that MIB A uses some functions in a file system MIB. Because of this dependency, MIB A cannot be executed until the file system MIB is operating. To avoid this problem, when the system manager installs each MIB, the system manager performs an internal resolution by validating that it can resolve all function calls in that MIB.

Basically, the system manager determines whether a particular MIB can be executed at that point in time. Referring to FIG. 3 and the MIBs listed in the CPG 16, the MIBs can be viewed as having interdependencies that are not immediately known when the CPG 16 is first powered up. As each MIB is loaded, it is hopefully resolved by the system manager 94. If the MIB is resolved (validated), it can be executed at that point in time. If, due to the interdependencies, the MIB cannot be resolved at that time, it is pushed down to the bottom of the loading cue until a later time. At some later point in time, another attempt to resolve that MIB is performed. If it still cannot be resolved, it again is pushed done in the cue. Eventually, most of the MIBs will have been resolved and loaded into the system. If a situation is ever reached where a MIB cannot be resolved, it is thrown out.

As described above, when a CPG 16 is first powered up, it performs a series of tasks (MIBs) in accordance with a bootstrap function. One of the last tasks to be executed is a proprietary SNMP agent MIB 86. As shown in FIG. 3, the SNMP agent MIB 86 is used by the CPG 16 to communicate with the outside world. Thus, the system manager 94 in the CPG 16 communicates with the SNMP agent MIB 86 through an internal API, while the SNMP agent 86 ultimately communicates with the EMS tool 12 through the Internet 88 and the telco CO 38. Once the SNMP agent 86 is started, the system manager 94 will send the SNMP agent 86 a request which directs the SNMP agent 86 to send a SNMP trap request to the appropriate EMS tool 12. An SNMP trap request is a message from the CPG 16 to the EMS tool 12, indicating that the state of the CPG 16 has changed. In the present discussion, the SNMP trap request is an indication to the EMS tool 12 that the state of the CPG 16 has changed to “booted.” The SNMP trap request is received by a trap listener 100 within the EMS tool 12. The trap listener 100 is able to isolate that SNMP trap request and determine from that message that a new CPG 12 is now on the network. Again, it should be understood that although the description herein makes reference to a CPG 12, any managed device, including routers, DSLAMS, class 5 switches, and the like, may send an SNMP trap request.

As part of the SNMP trap request, the newly powered up CPG 16 can send a multiple OIDs to the EMS tool 12. The OIDs are communicated as cascaded messages containing information about the CPG 16. For example, the SNMP trap request can communicate information such as device type, software version, hardware version, and the like. A description of the managed device can therefore be communicated within the SNMP trap request. The address information for the newly powered up CPG 16 may be included in the packet header, or it may be embedded in the payload.

Based on the description of the CPG 16, the EMS tool 12 may send SNMP “get” or “get next” requests to the CPG 16 to perhaps get additional information from the CPG 12. Within the SNMP “get” or “get next” request, one or more OIDs 72 are passed. In response, the CPG 16 may return the values associated with those OIDs. These values may pertain to the MIBs that are installed in the CPG 16, and may include, but is not limited to, the versions of the MIBs, the hardware version of the CPG 16, and if the CPG 16 is formed of several pieces of hardware, the version of each of these pieces of hardware.

Referring to FIG. 2, because the objects in a MIB 74 are structured like a tree, the OIDs 72 in a CPG 16 are cascaded so that one OID 72 may point to the next one, and that OID will point to the next one, and so on. Therefore, an SNMP “get next” request is basically a request to get the next object in the MIB 74.

After receiving this additional information, the EMS tool 12 may check its database to determine if the software versions of the MIBs in the CPG 16 are up to date. An internal release management system 102 in the EMS tool 12 is used to perform this check. The release management system 102 maintained in the EMS tool 12 contains a set of databases, one for each type of network device, and can therefore evaluate the software versions of a number of network devices, including routers, DSLAMs, class 5 switches, and the like. As stated earlier, the SNMP trap request sent by a network device indicates to the EMS tool 12 that the CPG 12 is booted, and also the identity of the network device. Within the release management system 102, the EMS tool 12 can then determine, for that particular device, the present release or software version, and what software version is the most up to date. If the software version is out of date, the EMS tool 12 can initiate a process to update the software versions in the network device.

The EMS tool 12 begins the software provisioning process by sending an SNMP set request to set an FTP address and software version number into the appropriate objects in the targeted MIB in the CPG 16. The SNMP agent MIB 86 periodically inspects the MIBs to locate these changed object values, and executes a software update function to communicate a software update request to the EMS server farm 80. One or more FTP release servers in the EMS server farm 80 receives the software update request, and determines one or more servers 84 in the EMS server farm 80 may be part of the same server as the EMS tool 12, or they can be separate servers distributed in a variety of geographic regions, coupled together over the Internet, or part of a private network. The FTP release server then assigns the request to one of the servers 84 according to traffic or location in order to achieve load balancing. The appropriate release of the software is downloaded from the selected server 84 to the CPG 16.

The above-described software provisioning process may be called a “pull” concept, because once information such as a new software version number and address is received by the CPG 16, the CPG 16 is responsible for pulling the new version of the software into itself from the EMS server farm 80. In alternative embodiments, a “push” concept may be employed, wherein the EMS tool 12 will communicate an SNMP “get” or “get next” command to the CPG 16 to push the software version onto the CPG 16.

In addition to software provisioning, the EMS tool 12 employs a generic methodology to manage services in a CPG 16 or other device that may publish an API for control, but not a remote API for control, and thus have no direct means of remote management. For example, a DHCP server does not have a published standard MIB for directly controlling its functionality. In such instances, the generic method of controlling such devices remotely, described herein, may be used. By using the EMS tool 12 to manage parameters for these services, the same generic API can be used.

Continuing the present example for purposes of illustration only, the EMS tool 12 will use a generic control function that is published to it by the system manager 94 to communicate an SNMP set request to the SNMP agent 86 within the CPG 16. The SNMP set request identifies the service to be controlled (e.g., the DHCP server MIB 98), the parameter to be controlled (e.g., parameter one), and the value of the parameter.

The SNMP agent 86 sends the service name, the parameter, and value to the system manager 94 intact, which then converts those values into internal API functions that can communicate with devices such as the DHCP server. As described above, once each MIB is registered, the system manager 94 is able to associate each MIB with a set of parameters and associated APIs. Thus, once the system manager 94 receives MIB and parameter information in an SNMP set request, the system manager 94 is able to determine which API to execute in order to control the parameter.

In addition, the EMS tool 12 may execute a reverse process to read a parameter from a particular MIB. For example, this reverse process of reading values from a particular MIB may be employed if a user has installed a managed device into a customer premise, but the device does not work. The EMS tool can be used to read the setup of that managed device for troubleshooting purposes.

An example of remote user and service provider access will now be provided, for purposes of illustration only. Assume that a user's home contains a smart refrigerator with an API used to control its functionality. Assume also that the smart refrigerator includes a scanner for scanning empty packages before disposal. By doing so, the smart refrigerator will be able to store an indication of particular items that need to be replaced. Further assume that the smart refrigerator communicates with a CPG 16 though an API.

As described in the U.S. utility application entitled “Device, System and Method for Providing Web Browser Access and Control of Devices in Customer Premise Gateways,” attorney docket no. 080632.0109, filed Jan. 12, 2001, assume that an embedded Web server in the CPG 16 publishes an initial access Markup-Language-type page displaying icons for each smart device, including an icon for a smart refrigerator. By clicking on Markup-Language-type page, a smart refrigeration Markup-Language-type page can be accessed. The smart refrigerator Mark-Language-type indicates which items need to be replaced, in accordance with the scanning procedure described above, and may also have controls for setting the internal temperature of the smart refrigerator.

This smart refrigerator Markup-Language-type page can be read and configured remotely. For example, while on vacation, the user can access the smart refrigeration Markup-Language-type using the Internet and issue a “replenish” command which causes the embedded Web server to communicate a message to an online grocer to deliver certain groceries to the user's home on the day that the user arrives home from vacation.

In the present example, the online grocer is the service provider. As an alternative means of keeping the user's smart refrigerator stocked, the service provider may be given access to the smart refrigerator Markup-Language-type page through an SNMP connection. Through this link, the online grocer may be able to perform service management tasks such as monitoring the list of items that need to be replaced, and automatically delivering groceries at the correct time.

Generally speaking, for every service operating within the customer premise, a service provider who want to control that service must have access to a EMS tool 12. For example, FIG. 1 illustrates an EMS tool 12 residing in a CO 38. This EMS tool 12 may be used by the telephone company to control managed devices within the CO 38, and perhaps smart telephones within customer premises, through broadband communication links such as DSL link 18. FIG. 1 also illustrates another EMS tool 12 located outside the CO 38. This EMS tool 12 may be used by other service providers from their own premises (such as the online grocer of the previous example) to manage smart refrigerators within customer premises through the Internet.

### EMS Tool Advertisement Manager

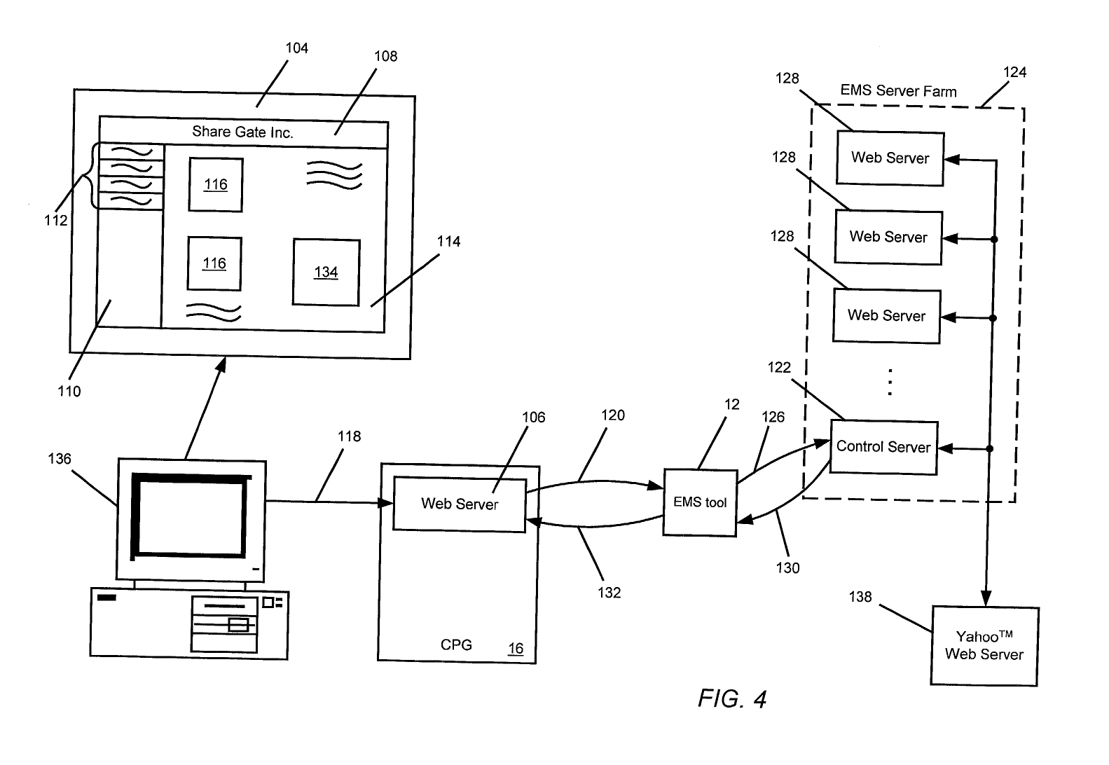

The following discussion is provided with reference to an advertisement manager feature of the present invention and FIG. 4. The advertisement manager is actually the springboard for a number of other technologies. As in the previous description of using SNMP and FTP in combination to provision a CPG, SNMP and HTTP will be used to provide web pages to the user. Fundamentally, the advertisement manager is a method for propagating advertisements onto an embedded server within the CPG.

First, the end product of what the end user will see will be described. Basically, the end user will see a web page called a home portal 104. The home portal 104 will be similar to Yahoo™ or Netscape™ or other customizable home web pages wherein the user can access that page from anywhere in the world via a web browser. The difference is a user's web browser will be pointed at a web server 106 embedded in their CPG 16. Thus, the user's home portal page 104 will be served by the CPG web server 106.

In one example embodiment of the present invention, the home portal page 104 may have a CPG logo 108 (e.g., a ShareGate logo) at the top and the rest of the web page 104 will be split such that on the left side there may be a Microsoft Outlook™ metaphor 110 having shortcuts 112 that can be moved. Those shortcuts 112 may be used to customize where the user would like to jump to quickly. There may be group bars so that the user can group these shortcuts 112 together. The icons that appear there may allow the user to navigate through other web pages that reside on the CPG 16 itself, because it does contain a web server 106. The Microsoft Outlook™ section 110 may be static (i.e., it will not normally change its look over time). The shortcuts 112 may provide access to typical web sites such as CNN.com™. The shortcuts 112 may also provide access to web pages containing an interface for controlling smart devices managed by the CPG 16. It should be noted that the web server 106 within the CPG 16 is a typical web server in that when a web browser, such as in an external PC web browser over the Internet, requests web pages from the web server 106, it will deliver those pages to the web browser. Thus, another feature of the home portal is that it will allow as user to remotely monitor a premise in the smart house concept.

Continuing the present example for purposes of illustration only, on the right side of the home portal page 104, there may be a newspaper metaphor 114. The newspaper section 114 will be dynamic (i.e., it will normally change its look over time). This is where advertisements 116 may be displayed, but rather than being merely advertisement space, it will be like a newspaper. The page 104 will have a “portal” look and feel, with SNMP and HTTP or FTP being used to modify this look and feel. This newspaper area 114 can be customized according to the end user's location. The newspaper 114 will have advertisements and text 116, and can be managed such that local advertisements can be sold in certain locations. The users will have the facility to generate this newspaper page 114, and it may be scrollable, up and down.

When an end user requests a page from the CPG 16, such as the Microsoft Outlook™ metaphor 110 or the newspaper metaphor 114, rather than having those pages stored in the web server 106 of the CPG, a technique called frameset redirection is used to fetch those pages from other locations. In frameset redirection, when the request 118 is received, the web server 106 then redirects the request to the EMS tool 12 (see reference character 120), which then redirects the request (see reference character 126) to a control server 122 in an EMS tool server farm 124. The control server 122 then determines a particular server 128 in the EMS tool server farm 124 where those web pages are located, fetches those pages, assembles them and then sends them back to the CPG web server 106 through the EMS tool 12 (see reference characters 130, 132).

The control server 122 is itself an EMS tool that is used to manage a graphically distributed set of HTTP web servers 128. The EMS server farm 124 is advantageous because of the desire to have fast content delivery time, and the desire to customize the newspaper page 114 to include local advertisements. For example, according to zip code, certain advertisements will be delivered to a particular CPG web server 106. The newspaper 114 can also be customized wherein a user can have specific information 134 appearing in the newspaper 114 or even specific advertisements and articles pertaining to a particular subject within the customized newspaper 114.

In one embodiment of the present invention, the EMS tool 12 constructs, configures, and configures the HTML newspaper page 114. In addition, the user may be given the ability to perform some additional customization of the newspaper page 114. For example, the end user may be able to enter a command indicating that the user is interested in sports, politics, etc. Beyond that, controls is given to the EMS tool 12, which can then push various articles or even advertisements specific to those categories onto the newspaper page 114. Pages relevant to these user-defined areas of interest may be stored somewhere in the EMS tool web server farm 124.

As previously discussed, the Microsoft Outlook™ metaphor 110 and the newspaper metaphor 114 can be customized according to the user's smart devices and location. However, these pages do not reside on the CPG web server 106, but are fetched from the web server farm 124. When the Microsoft Outlook™ or newspaper pages 110 or 114 are fetched from the EMS web server farm 124, there are links in those pages in the web server farm 124 which can redirect that server in the web server farm 124 back to the CPG web server 106. For example, for the Microsoft Outlook™ metaphor 110, the pages are first fetched generically from the EMS tool web server farm 124, but then the server in the web server farm 124 customizes that page by fetching information back from the CPG web server 106. When the generic page fetches unique information from the CPG web server 106, it does so because it has received information about the location of the CPG web server 106. It should be noted that in alternative embodiments, the Microsoft Outlook™ metaphor page 110 may also be fetched directly from the CPG web server 106 instead of from the web server farm 124.

However, fetching content directly from the CPG web server 106 is generally not done with the newspaper page 114, which may contain text and advertisements 116 specific to a particular location, and may also include information 134 on that user's home, such as the temperature of the house, the condition or status of smart appliances, etc. The newspaper 114 is generally first fetched from the web server farm 124 so that the localized text and advertisements 116 can be put into the newspaper 114. The newspaper page 114 may have links which direct the control server 122 in the web server farm 124 back to the web server 106 in the CPG 16 to fetch this user-specific information on the home devices. It also should be noted that in the newspaper metaphor 114, there may be links which fetch content from external web servers 138 such as Yahoo™, or other web servers external to the EMS tool web server farm 114.

In another embodiment of the present invention, the time that a particular advertisement would appear on the newspaper 114 may be controlled. In one embodiment, the advertisements may appear in different locations within the newspaper 114 at different times, or they may disappear altogether after a certain amount of time. A typical time limit might be one day for these advertisements to change locations or to disappear. In a newspaper, certain locations are more prime than others and cost more. Advertisers may want their advertisements to appear in different locations on different days and, thus, perhaps on a daily basis, the user may see new advertisements in new locations or the same advertisements appealing in different locations. Note that the advantage of the frame set redirection methodology is that the basic web pages stored on the CPG web server 106 need not change. All of the customization occurs in the EMS tool web server farm 124.

In a business application of one embodiment of the present invention, advertisers would pay the EMS tool server farm manager to have its advertisements run on these newspaper pages 114. However, it should be noted that the a user's external PC and web browser 136 can be configured so that when it is started up, it can point to any web page and thus it need not point to the home portal page 104 containing all of these advertisements. Thus, a user could bypass this newspaper page 114, if desired. Nevertheless, because the newspaper 114 is customizable by the user, and contains smart device control pages, and because the user does not have the ability to turn off the advertisements that appear in the newspaper 114, this bypassing may not be attempted by many users.

In another embodiment of the present invention, advertisements may be propagated onto an embedded server in mobile devices such as a palmtop PC. Such handheld devices employ wireless links to the Internet. With such devices, once a wireless link to an EMS tool is established, then, for example, as a user is walking through an airport, advertisements may be pushed onto certain web pages based on the airport he is in. Such a business arrangement might be realized in a situation where a user received an EMS modem free of charge, in exchange for having advertisements pushed onto your palmtop as the user walks in range of a particular EMS tool. In the present example, the palmtop PCs would have a web server, and the EMS tool would be capable of pushing advertisements onto that palmtop PC web server's pages so that as the user is looking at those pages in a particular location, the newspaper metaphor would be populated with localized advertisements and text. Perhaps using a GPS device within the palmtop PC, the web server might communicate through the wireless modem to the EMS tool, which would then push advertisements back onto that web server's home pages. If the user of this palmtop turned on the palmtop device and web server in a particular region, the EMS tool may immediately contacted and the advertisements pushed onto the page.

Therefore, embodiments of the present invention provide a system for remote management of telecommunications devices that do not have standardized device management protocols. Embodiments of the present invention also provide a tool for managing a customer premises gateway and smart devices coupled to the customer premises gateway, and provide a generic methodology to manage services for efficient installation of needed network and service provider upgrades in the customer premises gateway, execute service provider features, and enable collection and transmittal of data collected from the smart devices at the customer premise.

What is claimed is:

1. A method for remote management of network elements, comprising:
communicating existing software version information from one or more network elements;
checking the existing software version information against current software version information; and
provisioning those network elements containing outdated software versions by communicating a current software version to those network elements.

2. The method as recited in claim 1, further comprising:
communicating the existing software version information from the one or more network elements using a simple network management protocol (SNMP); and
communicating the current software versions to the network elements using SNMP.

3. A system for remote management of network elements, comprising:
at least one network element, the network element containing existing software versions of one or more software applications and capable of communicating existing software version information about the one or more software applications; and
an element management system tool including a processor and memory, the element management system tool coupled for receiving the existing software version information and comparing the existing software version information against stored current software version information;
wherein the element management system took is programmed for provisioning those network elements containing outdated software versions by communicating a current software version to those network elements.

4. The system as recited in claim 3:
wherein the at least one network element communicates the existing software version information about the one or more software applications using a simple network management protocol (SNMP); and
wherein the element management system tool is programmed for communicating the current software versions to the network elements using SNMP.

5. A method for propagating local content onto a local web server, comprising:
communicating a request for a web page to the local web server;
redirecting the request to a particular remote web server in a server farm comprised of a plurality of remote web servers, the particular remote web server containing the local content for the requested web page;
fetching the requested web page from the remote web server;
assembling the requested web page with the local content; and
communicating the web page back to the local web server.

6. The method as recited in claim 5, further comprising redirecting the request to a control server, the control server for determining the particular remote web server in the server farm that contains the local content for the requested web page.

7. The method as recited in claim 6, wherein the communications between the local web server, the control server, and the server farm are implemented using a simple network management protocol (SNMP).
